(19) United States
(12) Patent Application Publication
(10) Pub. No.: US 2008/0023400 A1
(43) Pub. Date: Jan. 31, 2008

(54) Water treatment system and method with a continuous partial flow bypass path

(76) Inventors: Steven D. Kloos, Chanhassen, MN (US); Pierre F. Sbabo, Shanghai (CN); Kenneth J. Sieth, Delafield, WI (US)

Correspondence Address: QUARLES & BRADY LLP, 411 E. WISCONSIN AVENUE, SUITE 2040, MILWAUKEE, WI, 53202-4497, US

(21) Appl. No.: 11/460,428

(22) Filed: Jul. 27, 2006

(51) Int. Cl. B01D 61/00

(52) U.S. Cl. 210/650; 210/652; 210/806; 210/259; 210/321.6; 210/433.1; 204/627; 204/518

(57) ABSTRACT

Many treatment systems remove virtually all minerals and other elements from the water, however a quantity of certain minerals and elements is necessary for good health and acceptable water taste. Therefore, a water treatment system is provided in which a portion of the input water bypasses the primary filtration and treatment components. The amount of that portion is selectively controlled so that a healthy level of minerals remains in the treated water, which still is extremely clean. An optional component can be included to reduce pathogens in the treated water.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to apparatus for treating water to remove chemicals and other impurities, and more particularly to ion separation systems, such as membrane separation apparatus.

2. Description of the Related Art

Many places in the world have very poor sources of potable water as the water contains contaminants or has an objectionable taste, odor and color, or a very high mineral content that is not healthy to drink. Various types of systems are employed to improve the water quality to provide clean and healthy water. “Clean” refers to an aesthetic property, where the water has a colorless appearance, no objectionable taste or odor and does not leave a residue or scum. “Healthy” refers to the composition of the water having a healthy level of minerals and acceptable levels of organics and metals with little or no chlorine or pathogens (e.g. protozoa, bacteria and viruses).

One type of treatment system utilizes reverse osmosis (RO) to purify the water. Point of use reverse osmosis water treatment systems are located under a countertop or sink in a kitchen or adjacent another place at which purified water is desired to be provided. The typical system comprises a pre-filter that employs a conventional filter medium, that removes relatively large particles as all the water being treated passes through the medium. The water exits the pre-filter and enters a reverse osmosis unit.

Reverse osmosis is a method that separates solutes from a solution by causing the solvent (such as water) to permeate a membrane by use of a pressure higher than the osmotic pressure. As water diffuses through the membrane, dissolved substances, such as salts, minerals and other contaminants are left behind so that the water that permeates the membrane has a lower concentration of dissolved substances. The remaining dissolved substances are flushed from the higher pressure side of the membrane through a restricted drain opening that helps maintain an increased pressure within the unit. The fluid from the drain opening may be sent to a sewer system or recycled through the water treatment system by a pump so that less water is wasted.

The treated water exiting the reverse osmosis unit may pass through an optional post-filter to improve the taste of the water that is affected when the system is not used for a prolonged period of time. A tank may also be provided at the output of the treatment apparatus to store the purified water. When needed, the purified water is drawn from the tank through a faucet.

A drawback of reverse osmosis is that is may be too effective in removing substantially all the minerals, such as calcium and magnesium, from the water. However, human consumption of certain minerals is necessary for good health, and many people believe it is important to have a healthy level of minerals in their drinking water. Also, many people believe that water with a moderate mineral content has a better taste than water with no minerals. As a consequence, the purified water from a reverse osmosis treatment system often is fed through a mineral bed to replenish the potable water with a healthy amount of desirable minerals. The mineral bed adds cost to the system and its storage vessel can be a source of bacteria.

Therefore, it is desirable to provide a water treatment system that provides a source of both clean and healthy water that contains amount of desirable minerals for good health and taste.

### SUMMARY OF THE INVENTION

A water treatment system comprises a water inlet port for receiving water to be treated and a water outlet port through which treated water flows. An ion separation module is fluidly connected between the water inlet port and the water outlet port and removes particles from water that flows there through. A bypass flow branch is connected between the water inlet port and the water outlet port in parallel with the ion separation module. The bypass flow branch has an orifice restricts the flow of water and thereby determines how much of the total volume of water flowing through the water treatment system travels through the bypass flow branch.

By allowing a portion of the water to travel around the ion separation module, some of the minerals in the source water remain in the treated water for health and taste reasons. The size of the orifice in the bypass flow branch controls the amount of those minerals.

Optionally a pre-filter can be connected upstream of the ion separation module to remove relatively large particles from the water flow, thereby increasing the operating life of the ion separation module. Another option, a post-filter can be connected downstream of the ion separation module to improve the taste of the water which may be adversely affected when the system is unused for a prolonged period of time. The water flowing through the system also may pass through a sterilization module to eliminate pathogens.

### DESCRIPTION OF THE OF THE DRAWINGS

FIG. 1 is a schematic diagram of a water treatment system that has a reverse osmosis unit with a continuous partial flow bypass path; and

FIG. 2 is schematic diagram of an alternative water treatment system according to the present invention.

### DETAILED DESCRIPTION OF THE INVENTION

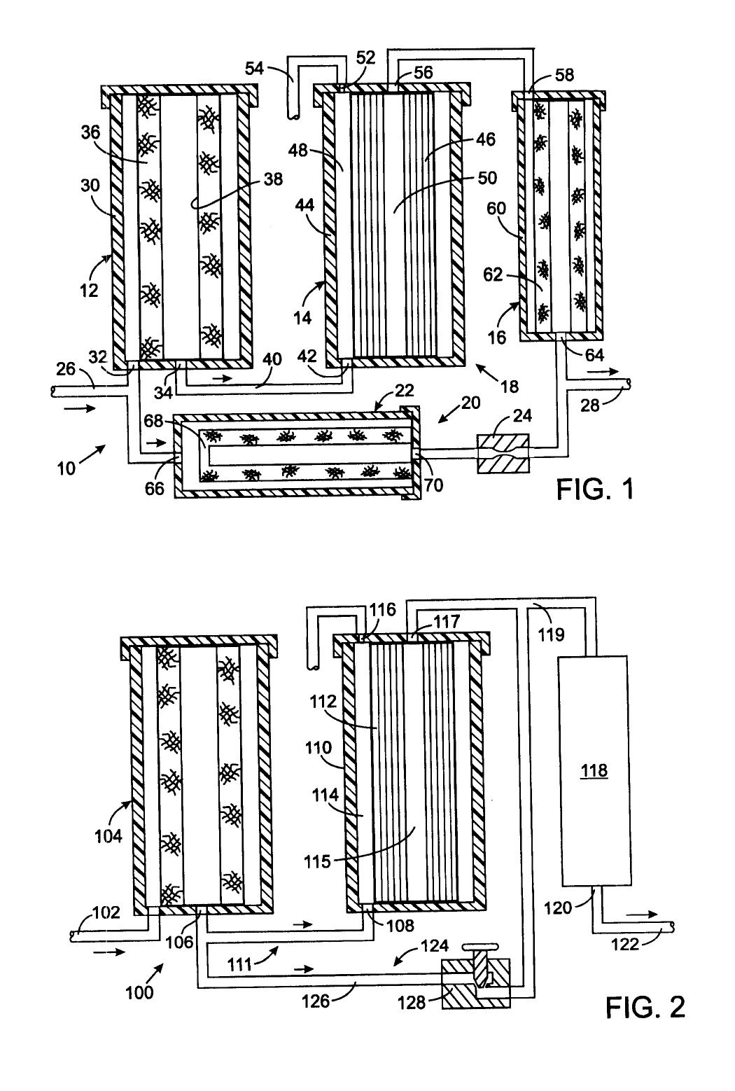

With initial reference to FIG. 1, a first water treatment system 10 comprises a pre-filter 12, an ion separation module 14 and a post-filter 16 that are connected in series forming a primary flow branch 18 of the system. A bypass flow branch 20 is connected in parallel with the primary flow branch 18 and comprises a bypass filter 22 and a flow control orifice 24. The two flow branches 18 and 20 are connected between a water inlet port 26 and a water outlet port 28.

The pre-filter 12 in the primary flow branch 18 includes a first container 30 having an inlet 32 adjacent an outer wall and a centrally located pre-filter outlet 34. Within the container 30 is a pre-filter cartridge 36 with a conventional filter medium, such as a tubular body of a spun fiber material through which the water flows to trap relatively large particles. If the source water is relatively free of large particles, the pre-filter 12 may be eliminated. The water to be treated enters the inlet 32 flows through the pre-filter cartridge 36 to a central bore which communicates with the pre-filter outlet 34. The pre-filter outlet 34 is connected by a conduit 40 to an inlet 42 of the ion separation module 14.

The ion separation module 14 has a standard ion separation membrane 46, such as a reverse osmosis membrane or a nano-filtration membrane, within a second container 44, thereby defining an outer chamber 48 and an inner chamber 50 that are separated by the membrane 46. Alternatively, the ion separation module 14 may comprise an electrodialysis device, an electrodialysis reversal device, a distillation unit, or a capacitive deionization device. The inlet 42 for the ion separation module 14 opens into one end of the outer chamber 48. A drain outlet 52 is located at the opposite end of the outer chamber 48 and is significantly smaller than the inlet 42. The size differential between the inlet 42 and the outlet 52 creates a pressure differential between the outer and inner chambers 48 and 50, which forces some of the water through the ion separation membrane 46 into the inner chamber 50 in a well known manner as in standard reverse osmosis systems. The drain outlet 52 is connected to a drain line 54 that either leads to a sewer system or may be recycled via a pump (not shown) to the water inlet port 26 of the treatment system, as is done in previous reverse osmosis water treatment systems for water conservation.

The ion separation module 14 has a treated water outlet 56, which is connected to an inlet 58 of the post-filter 16. The post-filter 16 has a third container 60 within which a conventional tubular-shaped filter medium 62 is located. The filter medium 62 for the post-filter 16 can be similar to that used in the pre-filter 12 but able to trap smaller particles, or it may be another type, such as a sediment filtration medium or activated charcoal. The treated water from the ion separation module 14 flows through the post-filter medium 62 exiting that filter via an outlet 64, which is connected to the water outlet port 28 of the first water treatment system 10. Thus, highly purified water passes from the primary flow branch 18 to the water outlet port 28.

As noted previously, such highly purified water is devoid of minerals, which are beneficial to a person's health, and is relatively tasteless. As a result, the bypass flow branch 20 provides a fluid path parallel to the primary flow branch 18 so that some minerals in the source water reach the water outlet port 28, thereby providing improved taste and beneficial minerals to the treated water. In particular, the water inlet port 26 for the first water treatment system 10 also is connected to an inlet 66 of a bypass filter 22. The bypass filter contains a filter medium similar to that used in the pre-filter 12. The bypass filter 22 has an outlet 70, which is connected by the orifice 24 to the water outlet port 28 of the first water treatment system 10. The size of the bypass orifice 24 is selected to determine the portion of the total water flow through the first water treatment system 10, which passes through the bypass flow branch 20. For example, when used where the feed water contains approximately twice the level of minerals that would be deemed to be healthy, the orifice would be set to allow about half of the feed water to enter the by-pass.

FIG. 2 depicts a second water treatment system 100 according to the present invention. Here a water inlet port 102 is connected only to the pre-filter 104, which has a similar construction to pre-filter 12 in FIG. 1 and removes relatively large particles from the water flow. The pre-filter outlet 106 is connected to a primary flow branch 111 containing an ion separation module 110, that has a membrane 112 such as a nano-filtration membrane or a reverse osmosis, for example. Specifically, the pre-filter outlet 106 is coupled to an inlet 108 which opens into one end of an outer chamber 114 of the ion separation module 110. A restricted drain outlet 116 at the opposite end of the outer chamber 114 creates a pressure differential between the outer chamber and an inner chamber 115. Thus, some of the water entering the outer chamber 114 is forced through the ion separation membrane 112 to a treated water outlet 117.

A bypass flow branch 124 is connected in parallel with that primary flow branch 111. The bypass flow branch 124 includes a conduit 126 that couples the outlet 106 of the pre-filter 104 to a variable orifice 128, such as provided by an adjustable valve. The variable orifice 128 allows a user to adjust the portion of the total flow through the second water treatment system 100 which passes through the bypass flow branch 124. This controls the amount of minerals which are allowed to bypass the primary flow branch 111 for health and taste reasons. The terminus of the bypass flow branch 124 is connected to a conduit 119 coupled to the treated water outlet 117 of the ion separation module 110 thereby combining the water flows from the primary and bypass flow branches 111 and 124.

That combined water flow is applied to a sterilization module 118, which may either treat the water flowing there through with light from an ultraviolet source or pass that water through a membrane that is capable of retaining pathogens. The sterilization module 118 eliminates pathogens from the water flow. The outlet 120 of the sterilization module 118 is coupled to the water outlet port 122 of the second water treatment system 100. Alternatively, a post filter, similar to the post-filter 16, may be inserted between the treated water outlet 117 of the ion separation module 110 and the inlet of the sterilization module 118.

It should be noted that the variable orifice 128 of FIG. 2 can be used in place of the fixed orifice 24 in the first water treatment system 10 in FIG. 1. Similarly, a fixed orifice can be utilized instead of the variable orifice 128 in the second water treatment system 100. In another variation, the sterilization module 118 can take the place of the post filter 16 in the first water treatment system 10 and the post-filter 16 can be employed in place of the sterilization module 118 in the second water treatment system 100.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A water treatment system comprising:
a water inlet port for receiving water to be treated;
a water outlet port through which treated water flows;
an ion separation module fluidly connected between the water inlet port and the water outlet port and removing contaminants from water that flows there through; and
a bypass flow branch connected between the water inlet port and the water outlet port in parallel with the ion separation module, and has an orifice that determines how much of a total amount of water flow through the water treatment system flows through the bypass flow branch.

2. The water treatment system as recited in claim 1 wherein the ion separation module further comprises a concentrate water outlet port through which contaminants that are removed from the treated water exits the water treatment system.

3. The water treatment system as recited in claim 2 wherein the ion separation module is selected from the group consisting of a reverse osmosis membrane module and a nano-filtration membrane module.

4. The water treatment system as recited in claim 1 wherein the ion separation module is selected from the group consisting of a reverse osmosis membrane module, a nano-filtration membrane module, an electrodialysis device, an electrodialysis reversal device, a distillation unit, and a capacitive deionization device.

5. The water treatment system as recited in claim 1 further comprising a pre-filter fluidly connected between the water inlet port and the ion separation module.

6. The water treatment system as recited in claim 1 further comprising a post-filter fluidly connected between the ion separation module and the water outlet port.

7. The water treatment system as recited in claim 1 further comprising a sterilization module fluidly connected between the ion separation module and the water outlet port, and reducing an amount of pathogens in the water.

8. The water treatment system as recited in claim 1 wherein the bypass flow branch further comprises a bypass filter connected in series with the orifice.

9. The water treatment system as recited in claim 1 wherein the orifice is variable.

10. The water treatment system as recited in claim 1 further comprising a pre-filter connected having an inlet connected to the water inlet port and having an outlet, wherein ion separation module is fluidly connected between the outlet and the water outlet port, and wherein the bypass flow branch is connected between the outlet and the water outlet port.

11. The water treatment system as recited in claim 1 wherein the orifice allows sufficient water flow though the bypass flow branch so that the treated water at the water outlet port contains a level of minerals that is considered to be healthy.

12. A water treatment method comprising:
receiving water from a source at an inlet port;
passing a first portion of the water from the source through an ion separation module which removes contaminants from the first portion of the water; and
passing a second portion of the water from the source through a bypass flow branch connected in parallel with the ion separation module thereby adding minerals to the first portion of the water that has passed through the ion separation module, wherein the bypass flow branch has an orifice that determines a quantitative relationship between the first portion and the second portion of the water from the source.

13. The water treatment method as recited in claim 12 further comprising passing a first portion of the water through a pre-filter prior to being passed through the ion separation module.

14. The water treatment method as recited in claim 12 further comprising passing all the water received from the source through a pre-filter.

15. The water treatment method as recited in claim 12 further comprising passing a first portion of the water through a post-filter after to being passed through the ion separation module.

16. The water treatment method as recited in claim 12 further comprising passing the first and second portions of the water through a sterilization module, to reduce an amount of pathogens.

17. The water treatment method as recited in claim 12 further comprising passing a second portion of the water through a bypass filter prior to being passed through the orifice.

18. The water treatment method as recited in claim 12 further comprising varying a size of the orifice.

19. The water treatment method as recited in claim 12 wherein passing a first portion of the water from the source through an ion separation module comprises passing the first portion of the water through a reverse osmosis membrane

20. The water treatment method as recited in claim 12 wherein passing a first portion of the water from the source through an ion separation module comprises passing the first portion of the water through a nano-filtration membrane.
